(19) United States
(12) Patent Application Publication
(10) Pub. No.: US 2023/0143670 A1
(43) Pub. Date: May 11, 2023

(54) Automated Image Acquisition System for Automated Training of Artificial Intelligence Algorithms to Recognize Objects and Their Position and Orientation

(71) Applicant: Cognivix s.r.l., San Giorgio (IT)

(72) Inventor: Daniele Bernardini, Munich (DE)

(21) Appl. No.: 17/916,283

(22) PCT Filed: Mar. 28, 2021
(86) PCT No.: PCT/EP2021/025116

§ 371 Date: Sep. 30, 2022

(30) Foreign Application Priority Data
Apr. 1, 2020 (IT) IT2020000006856

(51) Int. Cl. G06V 10/774; H04N 23/53; G06T 15/06; G06V 10/82

(52) U.S. Cl. CPC G06V 10/774; H04N 23/53; G06T 15/06; G06V 10/82; G06T 2215/16

(57) ABSTRACT

The present invention represents an automated system for training a machine learning algorithm for recognizing the position and orientation of objects. Given one or more objects and the corresponding three-dimensional mathematical model(s), the proposed system acquires, in an automated manner, images of the one or more objects under examination and generates, again in an automated manner, the parameters of a machine learning algorithm for recognising the objects for which training has been done. The system proposed in the present innovation comprises at least one optical image acquisition system, at least one mechanical system for moving the optical image acquisition system, or the object under examination, or both, to arbitrary positions in three-dimensional space, at least one screen (or other system) capable of generating arbitrary images, at least one electronic system, and at least one software system for controlling the optical image acquisition system, the mechanical positioning system, and for computing the weights of the neural network used for automatic recognition of the object for which the training has been done.

### CROSS-REFERENCE TO RELATED APPLICATIONS

This application is the United States national phase of International Application No. PCT/EP2021/025116 filed Mar. 28, 2021, and claims priority to Italian Patent Application No. IT2020000006856 filed Apr. 1, 2020, the disclosures of each of which are hereby incorporated by reference in their entireties.

### BACKGROUND OF THE INVENTION

### Field of the Invention

The present disclosure relates to systems and methods for automated obtaining of training data to be used in training of a trainable computer vision module.

### Description of Related Art

One example of the current state of the art for image acquisition for the training of a neural network to object recognition can be found for example in D. de Gregorio et al., “Semi-Automatic Labeling for Deep Learning in Robotics”, ARXIV.org, Cornell UniversityLibrary, 201 Olin Library, Cornell University Ithaca, N.Y. 14853. In the work of D. de Gregorio et al., the authors developed a semi-automatic method for the generation of datasets for the training of a neural network, that reduces the human intervention for the creation of large labeled datasets.

### SUMMARY OF THE INVENTION

An embodiment of the present invention provides an automated system that is capable of:
1. Acquiring (in an automated manner) images and labels for training an automatic object recognition algorithm.
2. The (fully automated) implementation of the training itself of the object recognition algorithm from the images.

### BRIEF DESCRIPTION OF THE DRAWINGS

The illustrations represent some of the possible implementations of the technology proposed in the description of the present invention. In particular, electromechanical positioning systems, electromechanical image acquisition systems, three-dimensional measurement systems as well as all other systems depicted together with their related geometries are intended as non-exhaustive examples.

FIG. 1 is a schematic representation of an image acquisition apparatus of one or more objects at various viewing angles and with arbitrary “backgrounds”. The apparatus, here represented schematically, processes in a fully automated way the acquired images and generates an artificial intelligence algorithm for the automatic recognition of the object or objects for which the images have been acquired.

FIG. 2 is a detailed schematic representation of the positioning of the optoelectronic image acquisition apparatus at arbitrary viewing angles θ and ϕ and distance R from the object under examination.

FIG. 3 is a detailed schematic representation of the initial placement of the optoelectronic system for image acquisition.

FIG. 4 is a schematic representation of the ray tracing procedure for determining the depth map of the object(s) under examination.

FIGS. 5a, 5b, and 5c are schematic detail representations of an electromechanical system for positioning the optoelectronic imaging system, comprising of a semicircular guide capable of rotating about its longitudinal axis and a support for the optoelectronic imaging system, capable of sliding along the semicircular guide. FIG. 5c also schematically depicts a motorized linear guide for varying the distance between the optoelectronic image acquisition system and the object under examination.

FIG. 6 is a detailed schematic representation of a motorized system for linear screen displacement along the x and y axis.

FIG. 7 is a detailed schematic representation of a motorized system for linear displacement of the screen along the x and y axis and rotation about the z axis.

FIG. 8 is a detailed schematic representation of a motorized system for positioning an optoelectronic imaging system at arbitrary viewing angles θ and ϕ of an object, exploiting three motorized linear guides and two motorized rotation systems.

### DETAILED DESCRIPTION

The goal of the proposed innovation is to further reduce the need for human intervention in the acquisition of large labeled datasets, e.g., for the training of an object recognition neural network or another trainable computer vision module. This would reduce or even eliminate the need for specialized personnel in the implementation of neural network based computer vision systems. This is particularly relevant in the industry, for those companies that either do not have a qualified R&D group in AI, or for the single projects that do not have a volume that justify the investment. In addition, in the proposed innovation, a large dataset of images with an object 2 (or multiple objects 2) on top of various different backgrounds are acquired, and a labeled datasets are extracted from these images. The acquisition of images of an object 2 together with various types of backgrounds is realized by the generation of the background images with a screen 3 with the object 2 placed on top of the screen 3. The use of a screen 3 (such as for instance a sufficiently large display or monitor) to generate and display the background images, allowing the acquisition of images of the real object on top of the background is central to the generation of proper images for the training. In the case of objects made of metal or for semi-transparent materials, such as for instance glass or plastic, reflection or transmission of the light (arising from the background) both change the images viewed and acquired by the optoelectronic acquisition image system 1. If the combined images of an object 2 under investigation with a background are generated with a different method, such as for instance via software overlaying the object on top of a background image, the effect of reflection and transmission would not be properly captured. Depending on the particular object under investigation the generated images may differ substantially by the images viewed and acquired by the optoelectronic acquisition image system 1 with important effects on the neural network training and the performance (e.g. accuracy) of the trained neural network. Given the frequency with which materials like metal plastic and glass and other reflective or semi-transparent materials are used in manufacturing, this improvement is fundamental to obtain an accurate dataset.

The screen 3 for the generation of the background images does not have to be necessarily a monitor. Other technologies could also be implemented. For instance images printed on paper or on different material could be used as the screen. In this case a screen 3 has to be able to change the printed images, similar to some commercial boards that are able to change between different commercials. Comparing the implementation of a screen 3 that comprises a system that exchanges printed images with a monitor, the use of a monitor offers the big advantage of a higher flexibility and a practically unlimited number of background images that can be used. Another exemplary implementation could use several materials with different reflectivity and colors, or even images printed on support made of different materials. The screen 3 could also be a holographic light-field display or another technology. Again different specific implementations for the screen 3 can be applied and can offer different advantages.

In other words, the screen may be an electronic display of any kind or a mechanic object or device which enables changing backgrounds for an object which is to be posed on the screen. In particular, the object is to be posed on the area of the screen showing the background.

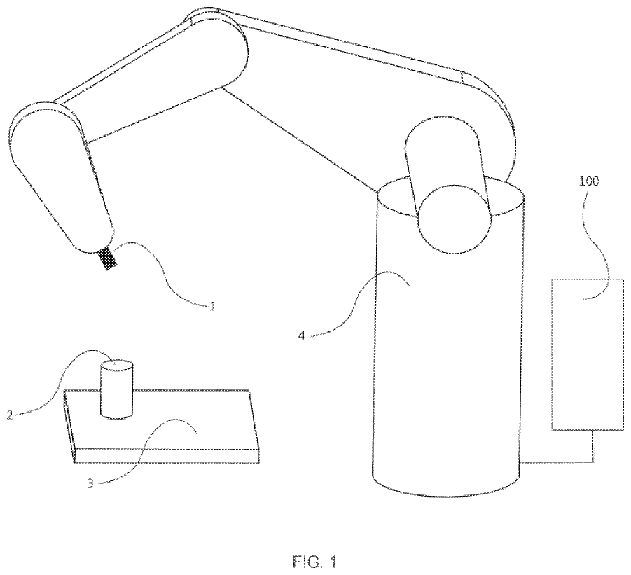

One possible Embodiment of the system is shown in FIG. 1. In this implementation, we have at least one electromechanical system 4 (e.g., a multi-axis industrial robot) capable of positioning at least one optoelectronic system 1 for image acquisition at multiple arbitrary points in space.

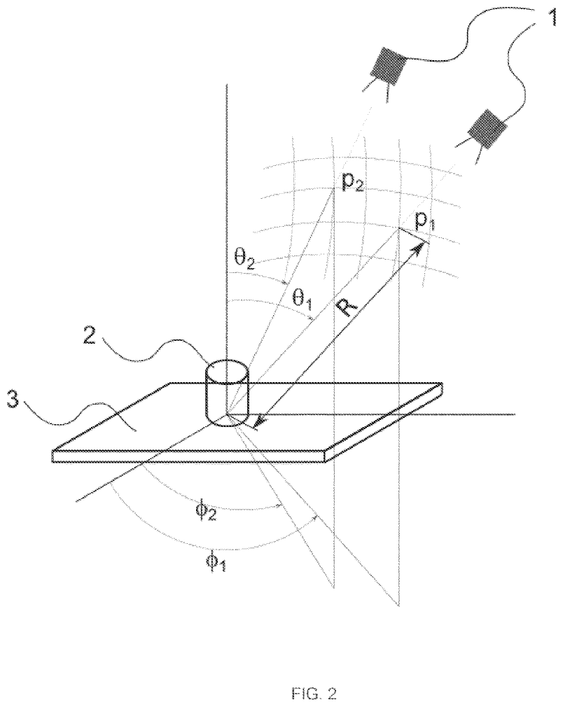

In this way, an arbitrary number of images at arbitrary angles θ and ϕ and arbitrary distances R object to image-acquisition system (see FIG. 2) can be acquired.

The term arbitrary here means that there is a plurality of possible locations in space in which the electromechanical system 4 can position the optoelectronic system 1 for the purpose of capturing an image of the object on (the top of) the screen. Thus, arbitrary may be understood as variable, configurable or controllable.

The system is equipped with at least one screen 3 or another device capable of generating arbitrary background images. The object under consideration 2 is positioned and held on the aforementioned screen 3 or other device capable of generating images. Images of object 2 on top of arbitrary background images generated by the screen 3 may be captured. The system has at least one electronic control system 100 and at least one software for controlling the relative movement of the image acquisition system 1 with respect to the object under examination 2, the optical image acquisition system 1, the screen 3, for processing the images, and for all mathematical calculation processes and numerical simulations necessary to produce the artificial intelligence algorithm for recognizing the object under examination in the images. The electronic system 100 may be a single electronic system or there may be multiple separate electronic systems for different tasks. Similarly, the system may have a single software that handles all of the above mentioned tasks or different software each dedicated to one of the specific tasks described above.

The first step in the automated acquisition and training process is to acquire images with the optoelectronic system 1 (e.g., a digital camera) in a vertical position, with the optical axis 5 perpendicular to the screen for generating the background images 3, as shown in FIG. 3. The object(s) 2 are positioned on the screen 3 also in their perpendicular position. Several images with cooperative backgrounds, such as homogeneous backgrounds of known color, are acquired. The combination of the geometry of the image acquisitions and the cooperative backgrounds allows a simple extraction of objects from the images. With classical image processing methods the center of the objects and the orientation angle around the optical axis 5 can be easily calculated.

The next step in the procedure is the acquisition of images at various projection angles and the determination of the depth map. At each image the position and orientation of the acquisition optics is also measured and, since the initial position of the objects is known, the position and orientation of the objects in three-dimensional coordinates with respect to the acquisition optics is calculated.

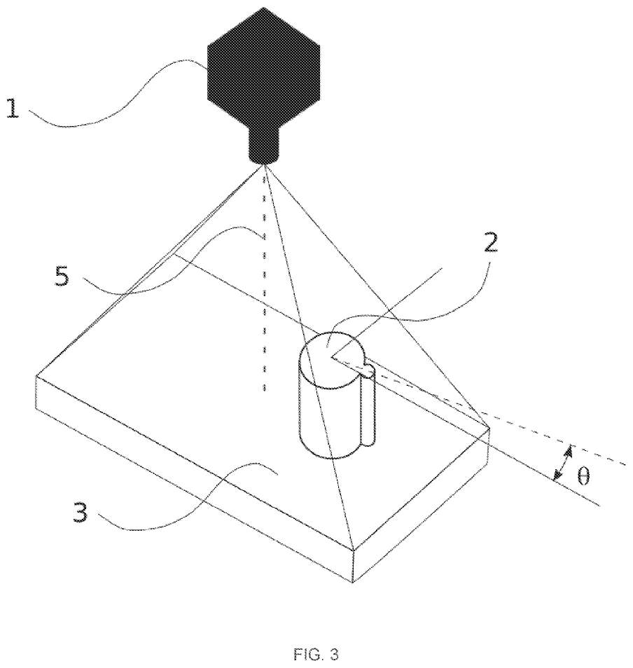

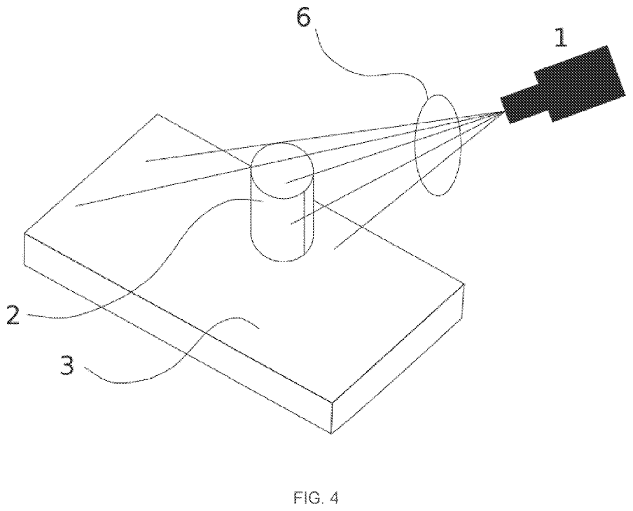

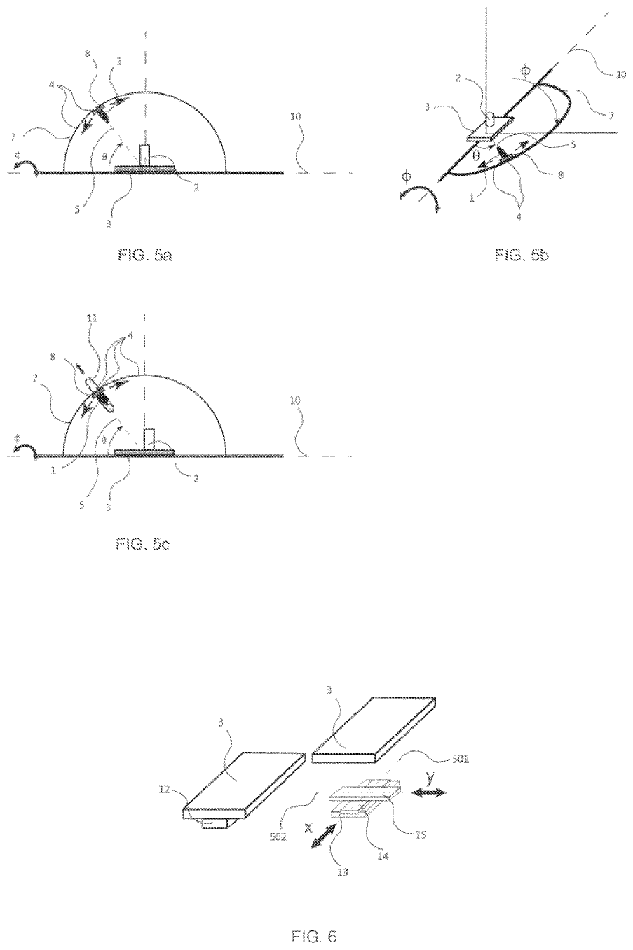

This allows to determine the depth map by means of “ray tracing” combined with the use of a mathematical model of the object 2 under examination. From the aperture of the acquisition system, various rays 6 are traced at various angles (see FIG. 4). Each particular ray 6 may or may not have an intersection with the surface of the test object 2 (more precisely, with its mathematical model). Rays that have intersection are assigned a digital value of “one” and those that do not have intersection are assigned the value “zero” (a negated assignment with values of “zero” and “one” reversed is entirely equivalent). The depth map contains information about which angles collect signal relative to object 2 and which angles collect signal from the background and thus which pixels of the acquisition system receive signal from the object and which from the background. The information including the position of the object and the depth map described above constitutes the necessary labeling for the subsequent training.

The next step is the acquisition of an arbitrary number (sufficiently large for effective training of the neural network) of images at various projection angles with different backgrounds. For each image acquired, labels are produced indicating which pixel belongs to which object or to the background, and the position and orientation of each object with respect to the optics.

The pre-processed images are passed to the electronic system for training.

These images can be subjected to a random modification process that acts simultaneously on the images and on the labels, so as to vary various aspects of the acquired data. A non-exhaustive list of examples includes: size i.e. distance from the optic, illumination, rotation with respect to the axis of the optic.

The training is then performed on a machine learning algorithm previously trained to recognize objects of various kinds. This allows a faster learning with a smaller amount of data than that required for a complete training from random initial parameters.

In another implementation of the system, in addition to the mechanical position system 4 of the optoelectronic image acquisition system 1 that could be for example a multi-axis industrial robot, an additional mechanical system 16 to rotate the screen 3 around an axis 503 perpendicular to the screen 3 might be included. This additional degree of freedom i.e. the rotation of screen 3 around an axis 503 perpendicular to screen 3 will offer the advantage of reducing the region of space that has to be covered by the optoelectronic image acquisition system 1. With a fixed (not rotating) screen 3 the optoelectronic image acquisition system 1 has to cover an azimuth angle of at least 360 degrees. This corresponds to a substantially large physical space that has to be covered by the image acquisition system 1 requiring a relatively large and therefore expensive mechanical position system 4. If it is considered for example that the screen 3 would be rotated by 180 degrees during the image acquisition, only half of the space i.e. only 180 degrees azimuth angle need to be covered by the mechanical position system 4. In principle the rotation of the screen would allow the use of mechanical position system 4 that does not have an azimuth degree of freedom. In a slightly modified implementation, two motorised linear guides 14,15 that allows movement in the xy plane could be implemented to move the screen along two mutually perpendicular axes x,y, both axis perpendicular to the rotation axis 503 of the screen 3. These additional two degrees of freedom permit to optimize further the image acquisition by the optoelectronic image system 1. The two additional degrees of freedom allow to optimally adjust the distance of the object 2 to the optoelectronic image system 1 without requiring a too large mechanical position system 4.

In another possible implementation of the system, the mechanical positioning system 4 may comprise an elevation and azimuth positioning system, as schematically shown in FIG. 5 a), b) and c). In this implementation, a semicircular shaped guide 7 is free to rotate about its longitudinal axis 10 and the angle is determined by an electromechanical actuator controlled by an electronic system. The optoelectronic image acquisition system 1 is mechanically mounted via a special movable support 8 to the semicircular guide 7 and is free to slide along it. Also in this case, the position along the guide is determined by an electromechanical actuator that can be controlled electronically. In this way, the optical axis 5 of the acquisition system can be positioned at an arbitrary combination of angles θ and ϕ relative to the screen 3. The mechanical system may optionally be equipped with a motorized linear guide 11 to vary the optical system-to-screen distance. The screen 3 may be mounted on a fixed support 12 or alternatively may be mounted on a motorized support 13 (e.g., equipped with two motorized linear guides 14,15 that allows movement in the xy plane. In this way, the object 2 (or any object) on the screen 3 can be positioned at an arbitrary position relative to the optical axis 5 of the acquisition system. This implementation does not require a multi-axis industrial robot and the mechanical positioning system 4 described above can be in principle less expensive compared to a multi-axis industrial robot with comparable extension and could be in principle even more precise.

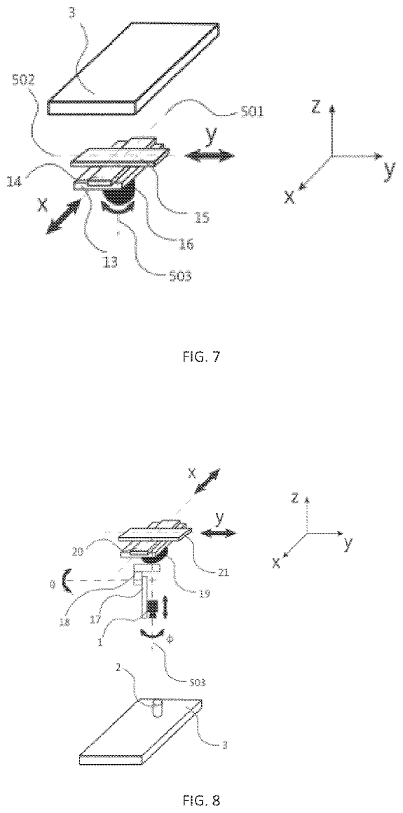

In a further variation of the system, the mechanical positioning system 4 can be realized using three motorized linear guides 17, 20, 21 and two motorized systems for rotation 18, 19. An optoelectronic image acquisition system 2 is assembled on a motorized linear guide 17, which in turn is assembled on a motorized rotation system 18, which allows variation of the viewing angle θ. The rotation system 18 is in turn assembled on a further motorized rotation system 19 which allows any azimuth viewing angle ϕ to be selected (see FIG. 8). The whole mechanical system described above 17, 18, 19, is in turn assembled to two motorized linear guides 20, 21 mounted perpendicularly which allow the movement of the optoelectronic image acquisition system 1 in the xy plane. In this way, various viewing angles θ and ϕ can be selected for the acquisition system 1. The distance R between the object 2 and the acquisition system 1 can also be varied. In this embodiment, the elevation angle θ is practically limited below a certain maximum value. However, this limitation is not a practical limitation of the implementation, as the industrial system that will go on to use the artificial intelligence algorithm produced by the system described in the present invention will also support limited elevation angles θ.

In another possible implementation of the present invention, the optoelectronic acquisition system 1 comprises at least one optical camera and at least one 3D sensor, such as a LIDAR, a dot projector, a structure-light projector, a multi-camera system, an ultrasonic system, or other multi-channel distance measurement system. In case a multi-camera system is used for three-dimensional object measurement, it can also be used for image acquisition. Having the measurement of the three-dimensional extent of the object, the profile of an object 2 can be measured, and from the measurements, the depth map can be calculated. At each position θ and ϕ (and possibly distance R) of the acquisition system in addition to the two-dimensional images, a profile of the object under consideration is also acquired. From the measurement of the profile is possible to deduce through a simple algorithm of analysis of distances measured which angles are related to the object and which to the “background”. Similarly to the case of the depth map generated by “ray tracing”, it is possible in this case too, the extraction of the object from the images acquired at arbitrary angles in a completely automated way.

In general, the present disclosure also provides an automated imaging equipment for use to generate training data to train machine learning algorithms for the recognition of objects and/or their location and orientation. The equipment includes an optoelectronic imaging system 1, an electromechanical system 4, a screen 3, and an electronic system 100. The electronic system 100 is configured to control the electromechanical system 4 to pose the optoelectronic imaging system 1 at predetermined distance R and/or angles θ and ϕ relative to an object 2. The electronic system 100 is further configured to control the screen 3 for displaying a predetermined background image 3. The object is to be posed onto the screen. This may be performed by the electromechanical system 4 or by another electromechanical system or manually. The electronic system 100 may be further configured to control the optoelectronic imaging system 1 to capture an image of the screen with the object posed on the screen while the screen is displaying the predetermined background image. Furthermore, the electronic system 100 may store the captured image into a storage module, medium or device, in association with one or more of a) the object identification, b) said distance and/or the angle(s), c) the background image identification.

In this paragraph the procedure for the acquisition of the training images is explained in detail.

The first step is a calibration of the optoelectronic image acquisition system 1. This calibration procedure is beneficial to determine the exact position of the reference frame of the optoelectronic image acquisition system 1 with respect to the reference frame of the electromechanical system 4. To perform the calibration some specific markers are imaged on the screen 3. The markers can be generated by the screen 3 or alternatively they can be printed on paper (or a plate of another suitable material) and the printed paper (or plate) positioned on the screen 3. Several images of the markers are acquired by the optoelectronic image acquisition system 1 at different viewing angles and positions of the optoelectronic image acquisition system 1. A specific algorithm is applied to analyse the acquired images and compute the coordinate transformation matrix between the reference system of electromechanical system 4 and the optoelectronic image acquisition system 1. Once the calibration of the optoelectronic image acquisition system 1 is performed it is necessary to determine the exact position on the screen of the object 2 under test. The object 2 under test is placed approximately in the middle of the screen 3. Images of the object 2 with a cooperative background (e.g. white homogen background) are acquired with the optoelectronic image acquisition system 1 placed approximately in the middle of the screen3 and with its optical axis perpendicular to the screen 3. The cooperative background allows a simple extraction of the image of the object 2 from the acquired images. Using these images a first approximation of the x and y coordinates of the object on the screen 3 plane are computed. If the object 2 under test does not have a perfect cylindrical symmetry around the z axis (axis perpendicular to the screen 3 surface) also a first approximation of the angle of the longitudinal axis of the object 2 with respect to the x (or alternatively the y) axis of the screen 3 is also computed.

The next step is the acquisition of several images of the object 2 under test appling always a cooperative background at different viewing angles and positions of the optoelectronic image acquisition system 1. The goal is to precisely determine the pose of the object 2 on the screen 3. The object 2 has in general a finite number of possible (i.e. stable) pose families on the screen 3. For instance if we consider a parallelepiped it can only lay in one of the faces. If the parallelepiped has a uniform color it would have only 3 distinguishable pose families. Using a mathematical model of the object 2 all distinguishable stable poses of the object 2 are computed. Each distinguishable stable pose familie is analyzed. The analysis starts with the mathematical model of the object 2 placed at the coordinate position x, y on the screen 3 and angle alpha with respect to the x axis of the screen 3 estimated as explained above in this paragraph. With the object 2 in this position a projected image on the image plane of the optoelectronic image system applying a simple ray tracing technique. From the aperture of the optoelectronic image system 1 various rays 6 are traced at various angles (see FIG. 4). Each particular ray 6 may or may not have an intersection with the surface of the mathematical model representing object 2. Rays that have intersection are assigned a digital value of “one” and those that do not have intersection are assigned the value “zero”. In this way a binary projected image of the object 2 is generated. Binary projected images are computed for every position of the optoelectronic image system 1 at which images of the abject 2 have been acquired. The projected images are compared with the (binarized) images acquired by the optoelectronic image system and a matching factor is computed. An optimization algorithm computes several times the process varying coordinates x,y and angle alpha to maximize the matching factor between projected and real (binarized) image. The coordinates x,y, alpha and pose family providing the maximum matching factor corresponds to the correct pose of the object 2. Alternatively, the system could implement only the initial vertical pose determination, or use only the optimization.

Once that the exact 6D position of the object 2 is determined, applying ray tracing it is immediate to determine which pixels of the acquired images belong to the object 2 which one belong to the background. A large number of images with various different backgrounds and different viewing angles and positions of the optoelectronic image system 1 can now be acquired and pre-analyzed i.e. object masks can be extracted by each acquired image. These pre-analyzed images, together with the masks and the position of the object, are suitable and can be directly used for the training of the neural network. It is noted that the present description is not limited to always modifying the position and the angle(s). It is conceivable to change, e.g. only one angle, for instance by capturing the object at the same distance from different angle azimuth angle but same elevation angle. Other combinations are possible (e.g. changing one of the angles only and the distance; or changing both angles but not the distance, or the like).

Once the images and the corresponding labels have been acquired the system can use these to perform the training of a preconfigured and pre-trained neural network using the electronic control system 100. It is noted that the electronic control system 100 may be distributed and that it may include more devices such as computers. Moreover, the system 100 may be used only for providing the training data. It does not necessarily have to implement the training.

Rather, the electronic control system 100 may acquire the labeled data and store them. The stored data may then be used at different time by other systems to train a neural network or other kind of artificial intelligence. The training data may be automatically retrieved from the storage and automatically employed for the training and evaluation of one or more neural networks.

One possible implementation of the training includes dividing the neural network layers in 2 different sets which will be referred to as the feature extraction, which is the part of the neural network taking as input the image and producing an intermediate output and the head that uses this intermediate output to produce the final output. In this implementation, in order to save time and computing power, only the head is retrained. In an alternative implementation, several sections of the network are identified and each section assigned a learning rate λ, with λ=0 corresponding to a blocked (not trained) section. The learning rates can be fixed or variable as a function of the measured accuracy during the training, for example decreasing the learning rate of sections of the network as the accuracy increases.

Reserving a class of images for accuracy measurements, therefore not used in the training, the system can determine independently if the training has reached a satisfactory result and produce the final neural network image, or optionally change the training strategy according to its programming.

One of the advantages of the present invention is the automation of the data acquisition and training from the insertion of the sample by the operator to the final generation of the trained neural network.

It is further included, according to an embodiment of the present invention a method for acquiring images and labels for the training of a neural network for image recognition comprising: loading a mathematical model of the object 2, computing physically stable poses of the object 2 using its geometry and density distribution, placing the object 2 onto the screen 3 for generating background images (approximately in the middle of the screen 3), positioning the optoelectronic image acquisition system 1 above the object 2 and perpendicular to the screen 3, acquiring images of the object 2 at this position with cooperative background e.g. uniform coloured background, estimating from the previously acquired images the approximate x, y position on the screen 3 of the object 2 (e.g. centre of mass of image energy distribution) and the orientation angle around a z axis perpendicular to the screen 3 (if the object does not have cylindrical symmetry around that axis), acquiring images of the object 2 with cooperative background (e.g. uniform coloured background) at different viewing azimuth angles ϕ, elevation angles θ, and at different distances R to the screen 3, computing the mask of the object 2 for each acquired image, generating projected (i.e. imaged) binary images of the 3D model of the object 2 onto the camera chip plane of the optoelectronic image system 1 for each position of the optoelectronic image system 1 for which images have been recorded with the object 2 being in one of the stable poses previously computed and at the coordinates x, y on the screen 3 and at the angle around an axis z perpendicular to the surface of the screen 3 (for instance described by the longest axis of the image with respect to axis x or y of the screen 3) previously estimated, for each pose computing a matching factor of the projected images with the binarised acquired images, for each stable poses recomputing the projected binary images in order to maximise the matching factor varying the positions x, y and angle around axis z of the object 2, selecting the stable pose and the position x, y and angle around axis z that provides the maximum matching i.e. determining the 6D pose of the object 2, acquiring images of the object 2 with general backgrounds at different viewing azimuth angles ϕ, elevation angles θ, and at different distances R to the screen 3, extracting the labels of the object 2 for the acquired images with general backgrounds using the previously determined 6D Pose of the object 2.

A method as described above further comprising as a preliminary step acquiring images of a set of markers on the screen 3 (generated by the screen 3 or printed on paper or different support placed on the screen 3) at different viewing azimuth angles ϕ, elevation angles θ, and at different distances R to the screen 3, computing the 6D position of the optoelectronic image system 1 with respect to the reference frame of the electromechanical system 4.

A method for generating in an automatic or semi-automatic way a trained neural network for the recognition of an object, comprising: placing the object 2 onto the screen 3 for generating background images, loading a mathematical model of the object 2, starting the process of image acquisition and training of the neural network using the electronic control system 100. According to an embodiment, a method is provided for automated imaging to obtain training data for training a machine learning algorithm for computer vision, the method comprising:
posing an optoelectronic system for capturing images (1) at a predetermined distance (R) and angle (θ, ϕ) relative to an object (2) located on a surface of the screen (3) which displays a background image,
displaying on the screen (3) the background image on said surface of the screen,
capturing the object located on the surface of the screen together with the screen while the screen displays the background image, and
storing the captured image in association with an identification of the object and/or the background image.

In an exemplary implementation, the method may further comprise, for said object, repeating the posing, the displaying, the capturing, and the storing steps for each combination out of a set of combinations of a) a predetermined distance and angle and b) a background image. Moreover, a computer program is provided which is stored on a computer-readable, non-transitory medium and comprising code instructions which when executed on one or more processors cause the one or more processor to perform the method as described above.

1. An automated imaging and processing equipment comprising:
at least one optoelectronic imaging system,
at least one screen controllable to display images on a surface of the at least one screen located below an object,
at least one electromechanical system controllable to place the optoelectronic imaging system at a distance R and an angle θ and an angle φ from the object, and
at least one electronic system which, in operation, controls:
the electromechanical system to place the optoelectronic imaging system at the distance R, the angle (θ) and the angle (φ) from said object,
the screen to display a background image on the surface of the screen located below the object, and
the optoelectronic imaging system to capture the background image displayed on the screen together with the object posed on the screen, wherein the captured image is stored in association with a label indicating the object.

2. The automated imaging and processing equipment according to claim 1, where the optoelectronic imaging system comprises at least one camera equipped with a two-dimensional focal plane array and an optical lens.

3. The automated imaging and processing equipment according to claim 1, wherein the electromechanical system comprises at least one multi-axis industrial robot.

4. The automated imaging and processing equipment according to claim 1, wherein the electromechanical system comprises at least one multi-axis industrial robot, at least one motorized mechanism for rotation around the z-axis, at least one motorized translation mechanism along an x-axis and at least one motorized translation mechanism along a y-axis of the screen.

5. The automated imaging and processing equipment according to claim 1, wherein the electromechanical system comprises at least one semi-circular guide that can rotate around a longitudinal axis thereof and at least one “holder” for the optoelectronic image capture system that is fixed to the semi-circular guide and able to flow along it.

6. The automated imaging and processing equipment according to claim 1, wherein the electromechanical system comprises at least two motorized rotation systems and at least three motorized linear guides.

7. The automated imaging and processing equipment according to claim 1, wherein the screen comprises at least one LCD screen, or at least one plasma screen, or at least one cathode tube screen, or at least one LEDs matrix screen, or at least one OLED screen, or at least one QLED screen, or at least one FED screen.

8. The automated imaging and processing equipment according to claim 1, where the optoelectronic imaging system comprises at least one chamber equipped with a two-dimensional focal plane array, at least one optical lens and at least one multichannel three-dimensional measurement system.

9. The automated imaging and processing equipment according to claim 1, wherein the optoelectronic imaging system comprises at least one multichannel system equipped with at least two chambers.

10. The automated imaging and processing equipment according to claim 1, wherein the electronic system, in operation, uses the captured image in association with said label to train an object recognition algorithm by machine learning.

11. The automated imaging and processing equipment according to claim 1, wherein the label comprises position of the object and/or a depth map.

12. The automated imaging and processing equipment according to claim 1, which, in operation, obtains the label which is a depth map according to a mathematical model representing the object and by applying raytracing.

13. The automated imaging and processing equipment according to claim 1, wherein the electronic system, in operation, for said object, repeats the controlling for a plurality of different background images.

14. The automated imaging and processing equipment according to claim 1, wherein the electronic system, in operation, for said object, repeats the controlling for a plurality of different combinations of the distance R, the angle (θ), and the angle (φ).

15. An automated imaging and processing equipment comprising:
at least one optoelectronic imaging system,
at least one electromechanical system for the placement of the optoelectronic system for capturing images at a distance R, and angle θ, and and angle φ from an object,
a screen for generating background images, the angle θ and the angle φ being an azimuth angle and elevation angle, wherein the screen is configured to generate arbitrary images on a surface below the object, and
at least one electronic system configured and programed to: control the electromechanical system, control the optical imaging system, process images obtained by the at least one optoelectronic imaging system, and train.

16. A method for automated imaging, the method comprising:
posing an optoelectronic system for capturing images at a predetermined distance R, an angle (θ), and an angle (φ) relative to an object located on a surface of the screen so that the screen is located below the object and displays a background image on the surface,
displaying on the screen the background image on said surface of the screen, and
capturing a captured image of the object located on the surface of the screen together with the screen while the screen displays the background image.

17. The method for automated imaging according to claim 16, further comprising storing the captured image in association with an identification of the object.

18. The method for automated imaging according to claim 16, further comprising using the captured image in association with the identification of the object to train an object recognition algorithm by machine learning.

19. The method for automated imaging according to claim 16, further comprising training a neural network that includes inputting of the captured image in association with the identification of the object to the neural network.

20. The method for automated imaging according to claim 16, further comprising:
repeating said steps of posing, displaying, and capturing for a plurality of different background images; and/or
repeating said steps of posing, displaying, and capturing for a plurality of different combinations of the distance R, the angle (θ), and the angle (φ) which comprises an azimuth angle and an elevation angle.

21. The automated imaging and processing equipment according to claim 8, wherein at least one multichannel three-dimensional measurement system is selected from LIDAR, a light structure projector, or an ultrasonic system.
